(19) United States
(12) Patent Application Publication
(10) Pub. No.: US 2010/0120994 A1
(43) Pub. Date: May 13, 2010

(54) Resin Composition

(75) Inventors: Toru SAITO, Nagano-ken (JP); Masaki IHARA, Nagano-ken (JP); Akinori YAMAMOTO, Nagano-ken (JP); Daisuke OGAYA, Nagano-ken (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/604,247

(22) Filed: Oct. 22, 2009

(30) Foreign Application Priority Data
Nov. 13, 2008 (JP) 2008-290662
Jun. 26, 2009 (JP) 2009-151994

(51) Int. Cl. C08L 83/00

(52) U.S. Cl. 525/474

(57) ABSTRACT

A resin composition is disclosed, which is obtained by polymerizing and curing a polymerizable composition at least containing:
component A: a compound having in one molecule at lease one episulfide structure represented by the following formula (1):

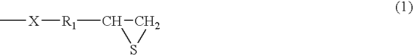

wherein X represents S or C, and R₁ represents C₁₋₁₀ hydrocarbon,
component B: a compound having per molecule at least one SH group, and
component C: an organosilicon compound represented by the following formula (2):

R¹ₘR²ₚSiX¹₄₋ₚ₋ₘ (2)

wherein R¹ is an organic group having a polymerizable reaction group, R² is a C₁₋₆ hydrocarbon group, X¹ is a hydrolytic group, m is 0 or 1, and p is 0 or 1,
the component C being present in a proportion of 6 parts by mass or more and 50 parts by mass or less per 100 parts by mass of the total of the component A and the component B.

### BACKGROUND

1. Technical Field

The present invention relates to a resin composition for producing spectacle plastic lenses and other plastic products.

2. Related Art

Spectacle plastic lenses are lightweight as compared with glass lenses, and also have various advantages including excellent formability and workability, low breakability, high safety, etc. They are therefore widely used in the fields of spectacle lenses, camera lenses, and the like.

For plastic lenses, at first, materials with a refractive index of 1.50 were widely used. However in recent years, for the purpose of providing lenses with reduced thickness, plastic lenses having high refractive index have been developed. As a resin material having high refractive index, a resin composition obtained by polymerization of an episulfide compound with a thiol compound has been proposed (see, e.g., JP-A-10-298287).

Also, a resin composition containing a disulfide-containing episulfide compound and a thiol compound already exists (see, e.g., JP-A-11-322930).

There also is a lens material containing a silane compound in a proportion of 0.0001 to 5 parts by weight relative to 100 parts by weight of the composition as an internal adhesion improver for increasing adhesion between a cured material and the mold (JP-A-2000-109478).

However, according to the related art of JP-A-10-298287 or JP-A-11-322930, when the amount of thiol compound is increased in order to reduce the yellowness of the lens material, then the heat resistance thereof is decreased.

On the other hand, when the amount of thiol compound is reduced in order to improve heat resistance, then the amount of episulfide compound is relatively increased, whereby the lens material becomes prone to yellowing.

Accordingly, the related art containing a thiol compound and an episulfide compound has a problem in that improvement of heat resistance and prevention of yellowing are incompatible.

In addition, according to the related art of JP-A-2000-109478, a silane compound is used as an internal adhesion improver, and, like the related art of JP-A-10-298287 or JP-A-11-322930, improvement of heat resistance and prevention of yellowing cannot be simultaneously achieved.

### SUMMARY

An advantage of some aspects of the invention is to provide a resin composition that allows to simultaneously achieve prevention of yellowing and improvement of heat resistance.

A resin composition according to an aspect of the invention is a resin composition obtained by polymerizing and curing a polymerizable composition that at least contains:

component A: a compound having in one molecule at lease one episulfide structure represented by the following formula (1):

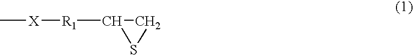

wherein X represents S or C, and R₁ represents C₁₋₁₀ hydrocarbon;

component B: a compound having per molecule at least one SH group; and

component C: an organosilicon compound represented by the following formula (2):

R¹ₘR²ₚSiX¹₄₋ₚ₋ₘ (2)

wherein R¹ is an organic group having a polymerizable reaction group, R² is a C₁₋₆ hydrocarbon group, X¹ is a hydrolytic group, m is 0 or 1, and p is 0 or 1,

the component C being present in a proportion of 6 parts by mass or more and 50 parts by mass or less per 100 parts by mass of the total of the component A and the component B.

According to the aspect of the invention, the compound having an episulfide structure serving as the component A and the thiol compound serving as the component B are contained. Although an increase in the amount of the component B to cope with yellowing results in a decrease in heat resistance, such a decrease in heat resistance is compensated for by component C. Further, because the component C is present in a proportion of 6 parts by mass or more and 50 parts by mass or less per 100 parts by mass of the total of the component A and the component B, yellowing can be coped simultaneously with improving heat resistance.

It is preferable that the component C is present in a proportion of 6 parts by mass or more and 20 parts by mass or less.

In this case, because of the component C proportion of 20 parts by mass or less, a resin composition having a high refractive index of 1.7 or more can be obtained.

The component A is preferably an episulfide compound represented by the following formula (3):

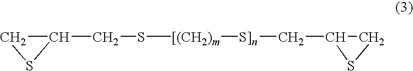

wherein m represents 0 to 6, and n represents 0 to 4.

The component A preferably has in one molecule at least one disulfide bond.

In each case, a product having high refractive index can be produced from the resin composition.

It is preferable that an internal release agent is further added to the polymerizable composition, and the polymerizable composition is then polymerized and cured.

In this case, when using a mold to polymerize the polymerizable composition, the polymerized and cured product can be smoothly released from the mold. This accordingly prevents application of force to the product upon release, which otherwise causes breaking or cracking of the polymerized and cured product.

It is preferable that the working surface of the mold that is used for polymerizing the polymerizable composition is coated with a release agent or subjected to surface treatment having a release effect.

In this case, a release agent is applied to the boundary portion between a product and the mold, or surface treatment having a release effect is performed, whereby the product can be released from the mold more smoothly.

It is preferable that water is further added to the polymerizable composition, and the polymerizable composition is then polymerized and cured.

In this case, addition of water to the polymerizable composition accelerates the reaction of a hydrolytic group, whereby heat resistance is further improved.

Taking the number of moles of hydrolytic groups in the component C in the polymerizable composition as Cm and the number of moles of water added as Hm, it is preferable that 0.1≦(Hm/Cm)≦3.

In this case, when the amount of water is within an appropriate range, the reaction is promoted, whereby heat resistance can be increased, and also the product is prevented from becoming clouded, providing good appearance.

That is, the reaction does not progress when the amount of water is too small, while when the amount of water is too large, the product becomes cloudy with poor appearance.

Further, it is more preferable that 0.1 (Hm/Cm) 2.

In this case, because (Hm/Cm) is 2 or less, a resin composition having a high refractive index of 1.7 or more can be obtained.

It is preferable that the resin composition is for spectacle plastic lenses.

In this case, a spectacle plastic lens having the above advantages can be produced.

### BRIEF DESCRIPTION OF THE DRAWINGS

The invention will be described with reference to the accompanying drawings, wherein like numbers reference like elements.

FIGS. 1A to 1C show a preparation step according to one embodiment of the invention.

FIG. 2 shows a concave part and a convex part for cast polymerization according to the embodiment.

FIG. 3 shows a casting mold for cast polymerization according to the embodiment.

FIG. 4 shows a raw material feeding device and a casting mold according to the embodiment.

FIG. 5 shows a curing step according to the embodiment.

FIG. 6 shows a plastic lens according to the embodiment.

FIG. 7 is a graph showing, regarding the Examples and Comparative Examples, the relation between the amount of component C added and the glass transition temperature and also the relation between the amount of component C added and the refractive index.

### DESCRIPTION OF EXEMPLARY EMBODIMENTS

Hereinafter, a method for producing a plastic lens according to the invention is explained in detail with reference to an embodiment. In this embodiment, a plastic lens for spectacles is taken as an example.

### Resin Composition

The resin composition for a spectacle lens produced in this embodiment is obtained by polymerizing and curing a polymerizable composition that contains component A comprising a compound having an episulfide structure, component B comprising a compound having per molecule at least one SH group, component C including an organosilicon compound, component D including water, and component E including an internal release agent.

The component C is added in a proportion of 6 parts by mass or more and 50 parts by mass or less, preferably 6 parts by mass or more and 20 parts by mass or less, per 100 parts by mass of the total of the component A and the component B.

Taking the number of moles of episulfide group (s) in the component A as Am and the number of moles of SH group (s) in the component B as Bm, 0.05≦Bm/Am≦0.8.

Taking the number of moles of hydrolytic groups in the component C as Cm and the number of moles of water of the component D added as Hm, 0.1 (Hm/Cm)≦3, and preferably 0.1≦(Hm/cm)≦2.

### Component A

Component A is a compound having in one molecule at lease one episulfide structure represented by the following formula (1-1)

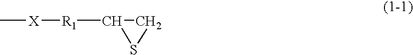

wherein X represents S or C, and R₁ represents C₁₋₁₀ hydrocarbon.

Among compounds represented by formula (1-1), the component A used in the embodiment is particularly an episulfide compound represented by the following formula (1-2)

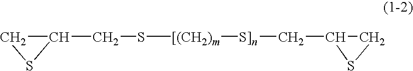

wherein m represents 0 to 6, and n represents 0 to 4.

As examples of episulfide compounds used in the embodiment, the following compounds can be mentioned.

Examples of episulfide-containing compounds include
bis(2,3-epithiopropyl)sulfide,
1,2-bis(2,3-epithiopropylthio)ethane,
1,2-bis(2,3-epithiopropylthio)propane,
1,3-bis(2,3-epithiopropylthio)propane,
1,3-bis(2,3-epithiopropylthio)-2-methylpropane,
1,4-bis(2,3-epithiopropylthio)butane,
1,4-bis(2,3-epithiopropylthio)-2-methylbutane,
1,3-bis(2,3-epithiopropylthio)butane,
1,5-bis(2,3-epithiopropylthio)pentane,
1,5-bis(2,3-epithiopropylthio)-2-methylpentane,
1,5-bis(2,3-epithiopropylthio)-3-thiapentane,
1,6-bis(2,3-epithiopropylthio)hexane,
1,6-bis(2,3-epithiopropylthio)-2-methylhexane,
1,8-bis(2,3-epithiopropylthio)-3,6-dithiaoctane,
1,2,3-tris(2,3-epithiopropylthio)propane,
2,2-bis(2,3-epithiopropylthio)-1,3-bis(2,3-epithiopropylthiomethyl)propane,
2,2-bis(2,3-epithiopropylthiomethyl)-1-(2,3-epithiopropylthio)butane,
1,5-bis(2,3-epithiopropylthio)-2-(2,3-epithiopropylthiomethyl)-3-thiapentane,
1,5-bis(2,3-epithiopropylthio)-2,4-bis(2,3-epithiopropylthiomethyl)-3-thiapentane,
1-(2,3-epithiopropylthio)-2,2-bis(2,3-epithiopropylthiomethyl)-4-thiahexane,
1,5,6-tris(2,3-epithiopropylthio)-4-(2,3-epithiopropylthiomethyl)-3-thiahexane,
1,8-bis(2,3-epithiopropylthio)-4-(2,3-epithiopropylthiomethyl)-3,6-dithiaoctane,
1,8-bis(2,3-epithiopropylthio)-4,4-bis(2,3-epithiopropylthiomethyl)-3,6-dithiaoctane,
1,8-bis(2,3-epithiopropylthio)-2,5-bis(2,3-epithiopropylthiomethyl)-3,6-dithiaoctane,
1,8-bis(2,3-epithiopropylthio)-2,4,5-tris(2,3-epithiopropylthiomethyl)-3,6-dithiaoctane,
1,1,1-tris{[2-(2,3-epithiopropylthio)ethyl]thiomethyl}-2-(2,3-epithiopropylthio)ethane,
1,1,2,2-tetrakis{[2-(2,3-epithiopropylthio)ethyl]thiomethyl}ethane,
1,11-bis(2,3-epithiopropylthio)-4,8-bis(2,3-epithiopropylthiomethyl)-3,6,9-trithiaundecane,
1,11-bis(2,3-epithiopropylthio)-4,7-bis(2,3-epithiopropylthiomethyl)-3,6,9-trithiaundecane,
   1,11-bis(2,3-epithiopropylthio)-5,7-bis(2,3-epithiopropylthiomethyl)-3,6,9-trithiaundecane, and like chain aliphatic 2,3-epithiopropylthio compounds;
1,3-bis(2,3-epithiopropylthio)cyclohexane,
1,4-bis(2,3-epithiopropylthio)cyclohexane,
1,3-bis(2,3-epithiopropylthiomethyl)cyclohexane,
1,4-bis(2,3-epithiopropylthiomethyl)cyclohexane,
2,5-bis(2,3-epithiopropylthiomethyl)-1,4-dithian,
2,5-bis{[2-(2,3-epithiopropylthio)ethyl]thiomethyl}-1,4-dithian,
   2,5-bis(2,3-epithiopropylthiomethyl)-2,5-dimethyl-1,4-dithian, and like cyclic aliphatic 2,3-epithiopropylthio compounds; 1,2-bis(2,3-epithiopropylthio)benzene,
1,3-bis(2,3-epithiopropylthio)benzene,
1,4-bis(2,3-epithiopropylthio)benzene,
1,2-bis(2,3-epithiopropylthiomethyl)benzene,
1,3-bis(2,3-epithiopropylthiomethyl)benzene,
1,4-bis(2,3-epithiopropylthiomethyl)benzene,
bis[4-(2,3-epithiopropylthio)phenyl]methane,
2,2-bis[4-(2,3-epithiopropylthio)phenyl]propane,
bis[4-(2,3-epithiopropylthio)phenyl]sulfide,
bis[4-(2,3-epithiopropylthio)phenyl]sulfone,
   4,4′-bis(2,3-epithiopropylthio)biphenyl, and like aromatic 2,3-epithiopropylthio compounds. These may be used singly or in combination of two or more kinds.

Examples of compounds having in the molecule at least one disulfide bond (S—S) and also having an episulfide group include bis(2,3-epithiopropyl)disulfide and like (thio)epoxy compounds having one disulfide bond in the molecule; and
bis(2,3-epithiopropyldithio)methane,
bis(2,3-epithiopropyldithio)ethane,
bis(6,7-epithio-3,4-dithiaheptane)sulfide,
1,4-dithian-2,5-bis(2,3-epithiopropyldithiomethyl),
1,3-bis(2,3-epithiopropyldithiomethyl)benzene,
1,6-bis(2,3-epithiopropyldithiomethyl)-2-(2,3-epithiopropyldithioethylthio)-4-thiahexane,
   1,2,3-tris(2,3-epithiopropyldithio)propane, and like thioepoxy compounds having two or more disulfide bonds in the molecule. These may be used singly or in combination of two or more kinds.

As a monomer compound, one of these compounds may be selected and used singly, or alternatively, two or more compounds may also be selected and used in combination.

### Component B

Component B is a thiol compound having per molecule at least one SH group.

Specific examples of thiol compounds include, but are not limited to, methyl mercaptan, ethyl mercaptan, 1,2-ethanedithiol, 1,2-propanedithiol, 1,3-propanedithiol, 2,2-propanedithiol, 1,4-butanedithiol, 1,2,3-trimercaptopropane, tetrakis(mercaptomethyl)methane, 1,2-dimercaptocyclohexane, bis(2-mercaptoethyl)sulfide, 2,3-dimercapto-1-propanol, ethyleneglycol bis(3-mercaptopropionate), diethyleneglycol bis(3-mercaptopropionate), diethyleneglycol bis(2-mercaptoglycolate), pentaerythritol tetrakis(2-mercaptothioglycolate), pentaerythritol tetrakis(3-mercaptopropionate), trimethylolpropane tris(2-mercaptothioglycolate), trimethylolpropane tris(3-mercaptopropionate), 1,1,1-trimethylmercaptoethane, 1,1,1-trimethylmercaptopropane, 2,5-dimercaptomethylthiophane, 4-mercaptomethyl-1,8-dimercapto-3,6-dithiaoctane, 2,5-dimercaptomethyl-1,4-dithian, 2,5-bis[(2-mercaptoethyl)thiomethyl]-1,4-dithian, 1,3-cyclohexanedithiol, 1,4-cyclohexanedithiol, 4,8-dimercaptomethyl-1,11-dimercapto-3,6,9-trithiaundecane, 4,7-dimercaptomethyl-1,11-dimercapto-3,6,9-trithiaundecane, 5,7-dimercaptomethyl-1,11-dimercapto-3,6,9-trithiaundecane, and like aliphatic thiols; and benzylthiol, thiophenol, 1,2-dimercaptobenzene, 1,3-dimercaptobenzene, 1,4-dimercaptobenzene, 1,2-bis(mercaptomethyl)benzene, 1,3-bis(mercaptomethyl)benzene, 1,4-bis(mercaptomethyl)benzene, 2,2′-dimercaptobiphenyl, 4,4′-dimercaptobiphenyl, bis(4-mercaptophenyl)methane, bis(4-mercaptophenyl)sulfide, bis(4-mercaptophenyl)sulfone, 2,2-bis(4-mercaptophenyl)propane, 1,2,3-trimercaptobenzene 1,2,4-trimercaptobenzene, 1,2,5-trimercaptobenzene, and like aromatic thiols.

### Component C

Component C is an organosilicon compound represented by the following formula (2):

R¹ₘR²ₚSiX¹₄₋ₚ₋ₘ (2)

wherein R¹ is an organic group having a polymerizable reaction group, R² is a C₁₋₆ hydrocarbon group, X¹ is a hydrolytic group, m is 0 or 1, and p is 0 or 1.

Specific examples of such silane compounds include vinyltrialkoxysilane, vinyltrichlorosilane, vinyltri(β-methoxy-ethoxy)silane, allyltrialkoxysilane, acryloxypropyltrialkoxysilane, metacryloxypropyltrialkoxysilane, metacryloxypropyldialkoxymethylsilane, γ-glycidoxypropyltrialkoxysilane, β-(3,4-epoxycyclohexyl)-ethyltrialkoxysilane, mercaptopropyltrialkoxysilane, and γ-aminopropyltrialkoxysilane, N-β-(aminoethyl)-γ-aminopropylmethyldialkoxysilane. Two or more of these silane compounds may be used in mixture.

### Component E

Component E is an internal release agent.

As the internal release agent, tetra-n-butylammonium bromide can be mentioned, for example. Further, various surfactants and the like may also be used. In addition to the above substances, the following substances may also be added to the polymerizable composition.

For example, tertiary amines, phosphines, Lewis acids, radical polymerization catalysts, cationic polymerization catalysts, or the like are usually used as curing catalysts for use in polymerization reaction. Further, if necessary, chain elongation agents, cross linking agents, light stabilizers, ultraviolet absorbers, antioxidants, coloring inhibitors, dyes, bulking agents, and like various substances may also be added.

Production of Plastic Lens

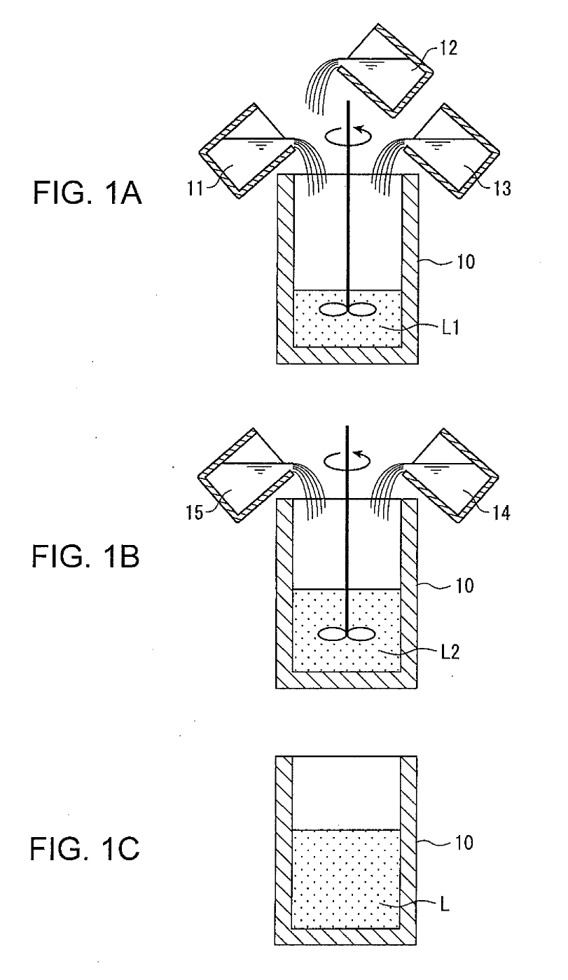

First, the outline of the process of producing a lens by cast polymerization according to the embodiment is explained with reference to FIG. 1A to FIG. 6.

FIGS. 1A to 1C show a preparation step according to one embodiment of the invention. First, as shown in FIG. 1A, component A indicated by numeral 11, component B indicated by 12, and component C indicated by 13 are added and stirred to prepare a composition L1. Subsequently, as shown in FIG. 1B, component D indicated by numeral 14 and component E indicated by 15 are added to prepare a composition L2, which is then stirred to finally give a resin composition L as shown in FIG. 1C. In this embodiment, the timing of addition of the components is not limited to the above example. For example, all the components may be added simultaneously and stirred altogether. Further, although the component A, component B, component C, component D, and component E are all liquid in FIGS. 1A to 1C, the state is not limited to liquid and may also be solid (powder, etc.).

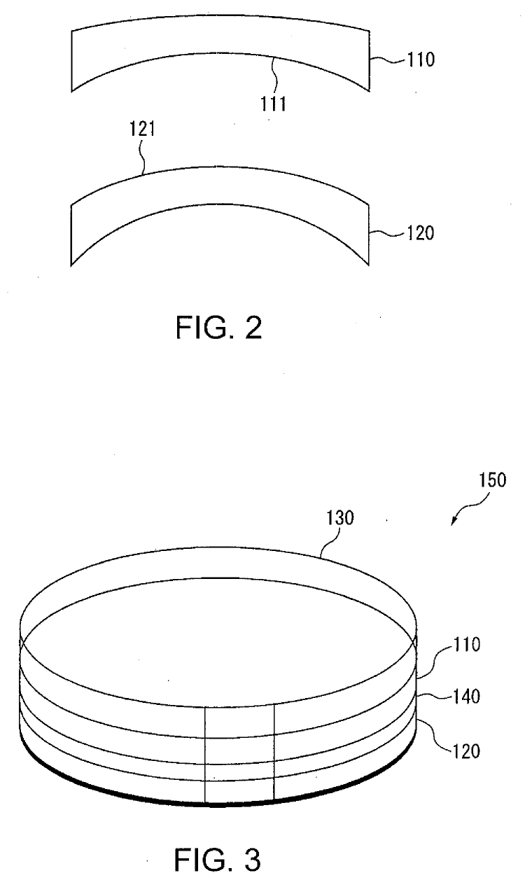

FIG. 2 shows a concave part and a convex part for cast polymerization according to one embodiment of the invention. As shown in FIG. 2, a concave part 110, as washed, having a convex-forming surface 111 that forms the convex surface of a lens and a convex part 120, as washed, having a concave-forming surface 121 that forms the concave surface of a lens are prepared.

FIG. 3 shows a casting mold for cast polymerization according to one embodiment of the invention. As shown in FIG. 3, these convex-forming surface 111 and concave-forming surface 121 are placed in an opposing manner. An adhesive tape 130 is wound around the peripheral surfaces of the concave part 110 and the convex part 120 to seal the cavity 140 between these molds, thereby assembling a casting mold 150.

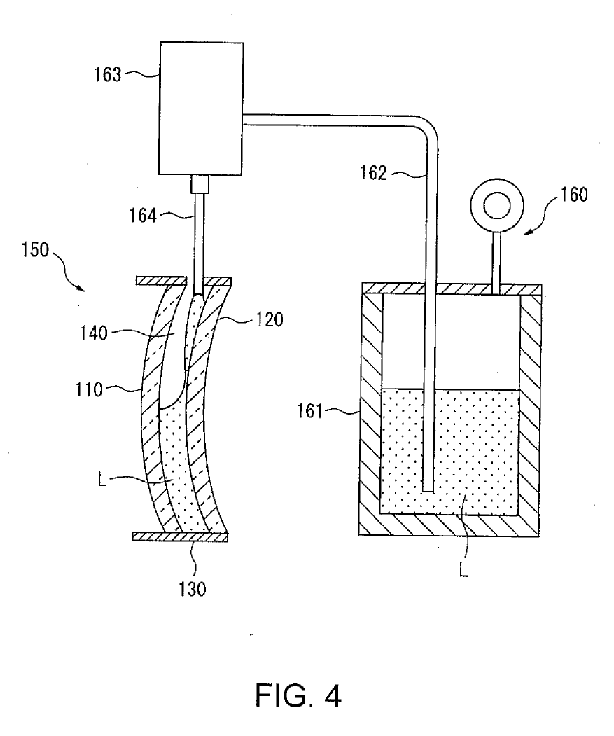

FIG. 4 shows a raw material feeding device and a mold according to the embodiment. As shown in FIG. 4, the prepared resin composition L is distributed from the raw material preparation tank to a storage container 161, a pressure vessel of a raw material storage/feeding device 160. The raw material storage/feeding device 160 is conveyed to the place where injection into the mold is performed, and then an injection step is performed. Specifically, a pressure gas is introduced into the storage container 161 so that the resin composition L in the storage container 161 is extruded through an injection pipe 162 and a valve 163 and discharged from an injection nozzle 164 into the cavity 140 of the assembled casting mold 150 to thereby fill the cavity 140.

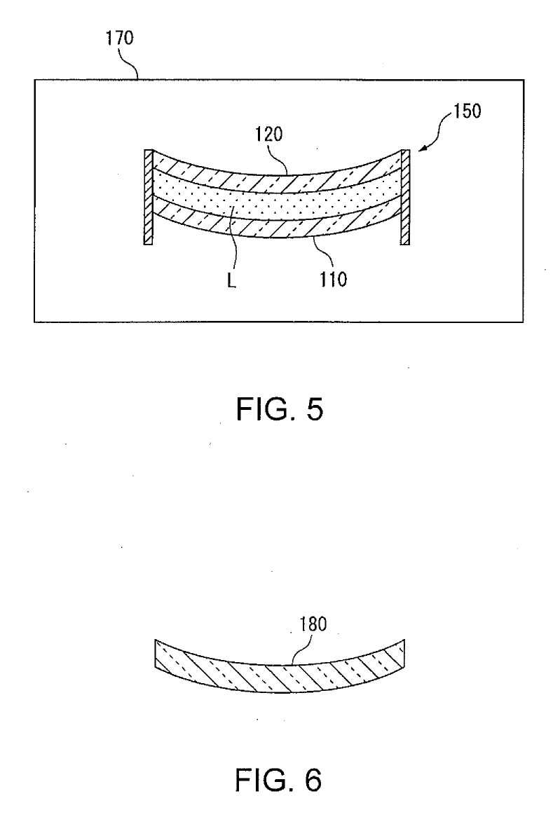

FIG. 5 shows a curing step according to one embodiment of the invention. As shown in FIG. 5, in the curing step, the casting mold 150 is placed in a thermostatic chamber 170, and then the casting mold 150 is exposed to an environment at a predetermined temperature for a predetermined time, thereby polymerizing and curing the resin composition L contained therein.

Finally, FIG. 6 shows a plastic lens in the embodiment. As shown in FIG. 6, the concave part 110 and the convex part 120 that form the lens-forming mold are removed from the cured plastic lens to give a plastic lens 180. In this case, prior to use, the working surfaces of the concave part 110 and the convex part 120 may be coated with an external release agent, such as a surfactant diluted with IPA to 1000 ppm, by spin coating, followed by drying. Further, the working surfaces of the concave part 110 and the convex part 120 may also be subjected to water-repellent treatment with a commercial water-repellent finishing agent for glasses.

Hereinafter, the above steps will be described in further detail.

Preferably used as a casting mold 150 is, for example, a casting mold 150 as shown in FIG. 3 consisting of two pieces of glass supported at the sides with an adhesive tape 130 or a mold supported at the side by a gasket.

In the injection step, first, a pilot hole is formed in a predetermined position of the adhesive tape 130, and the injection nozzle 164 is inserted into the non-illustrated pilot hole. The space between the concave part 110 and the convex part 120 at the outer periphery of the casting mold 150 for convex lenses is small. Accordingly, in order to enable insertion thereinto, an injection nozzle 164 with an extremely thin tip is used. A pressure gas is introduced into the storage container 161 to extrude the resin composition L contained in the storage container 161 through the injection pipe 162 and the valve 163 to the injection nozzle 164, thereby injecting the resin composition L into the cavity 140. As completion of the filling of the cavity 140 with the resin composition L is detected, then the valve 163 is closed to stop injecting, and the inlet is sealed.

Subsequently, the method for producing the plastic lens 180 according to the embodiment has a curing step that exposes the casting mold 150 to predetermined temperature conditions to polymerize and thereby cure the resin composition L in the casting mold 150.

Standard polymerization conditions are as follows. The starting temperature is about 10 to about 30° C. Then, the temperature is increased over about 20 to about 40 hours to the maximum temperature of about 100 to about 140° C. to achieve polymerization. After polymerization, the mold is removed from the thermostatic chamber 170. The mold is separated from the cured plastic to remove the same, thereby giving a plastic lens.

Such cast polymerization of a plastic lens 180 provides a finished lens in case where the both faces of the plastic lens 180 are processed to have predetermined optical surfaces by transcription from the casting mold 150, or otherwise provides a semi-finished lens in case where one face thereof is processed to have an optical surface by transcription from the casting mold 150, while the other face is filed by polishing to have an optical surface.

Generally, a finished lens is thin. In both cases of a concave lens and a convex lens, the minimum thickness is about 1 mm. In contrast, a semi-finished lens is slightly thicker. In both cases of a concave lens and a convex lens, the minimum thickness is about 5 to about 20 mm.

The temperature at the time of removing a polymerized plastic lens from the mold is about 100° C. or less, for example, and more preferably 70° C. or less. The time taken to reduce the temperature from the maximum temperature is about 1 to about 5 hours. The temperature may be forcibly lowered so that the time of temperature reduction is about 1 hour.

In order to stabilize the power of the obtained plastic lens 180 or to eliminate the optical strain of the lens, the plastic lens 180 removed from the casting mold 150 is preferably reheated and subjected to annealing treatment. The treatment temperature at this time is 70° C. to 160° C., and preferably 80° C. to 130° C. The treatment time is 10 minutes to 6 hours, and preferably 1 hour to 3 hours.

When the polymerized and molded plastic lens 180 is a finished lens, polishing is not performed, and other treatment steps such as dyeing, formation of a hard coat film, formation of an antireflection film, and the like are performed as required, thereby giving the final plastic lens 180.

When the polymerized and molded plastic lens 180 is a semi-finished lens, one face thereof is polished to have a predetermined optical surface. After polishing, other treatment steps such as dyeing, formation of a hard coat film, formation of an antireflection film, and the like are performed as required, thereby giving the final plastic lens 180.

### EXAMPLES

### Example 1

As component A, 80 g of bis(2,3-epithiopropyl)disulfide (A1) was prepared. A1 has a molecular weight of 210.4, and the number of moles Am of episulfide groups in the component is 0.760. A1 has in one molecule two episulfide structures.

As component B, 20 g of mixture (B1) of 4,8-dimercaptomethyl-1,11-dimercapto-3,6,9-trithiaundecane, 4,7-dimercaptomethyl-1,11-dimercapto-3,6,9-trithiaundecane, and 5,7-dimercaptomethyl-1,11-dimercapto-3,6,9-trithiaundecane was prepared. B1 has a molecular weight of 366.7, and contains four SH groups. The number of moles Bm of SH groups in the component is 0.218. Accordingly, the molar ratio Bm/Am between the component A and the component B is 0.287.

As component C, 6 g of γ-glycidoxypropyltrimetoxysilane (C1) was prepared. C1 has a molecular weight of 236.3, and contains three hydrolytic groups.

As component E, 10 ppm of tetrabutylammonium bromide (E1) was prepared.

In Example 1, a composition comprising these components A, component B, component C, and component E was produced, the composition was injected into a casting mold for cast polymerization, and a plastic lens was produced by the method according to the embodiment.

The polymerization conditions were as follows. The starting temperature was 25° C. Then, the temperature was increased over 24 hours to the maximum temperature of 130° C. to achieve polymerization. Subsequently, after cooling to 70° C., the mold was removed to release the lens from the mold. The lens was then subjected to annealing treatment at 120° C. for 2 hours. The inside of the mold was not subjected to any mold release treatment, such as treatment with an external release agent, etc.

### Example 2

In Example 2, the amount of component C is larger than in Example 1. Specifically, in Example 2, the amount of component C is 10 g, while other conditions are the same as in Example 1.

### Example 3

In Example 3, the amount of component C is larger than in Examples 1 and 2. Specifically, in Example 3, the amount of component C is 20 g, while other conditions are the same as in Examples 1 and 2.

### Example 4

In Example 4, the amount of component C is larger than in Examples 1 to 3. Specifically, in Example 4, the amount of component C is 30 g, while other conditions are the same as in Examples 1 to 3.

### Example 5

In Example 5, the amount of component C is larger than in Examples 1 to 4. Specifically, in Example 5; the amount of component C is 40 g, while other conditions are the same as in Examples 1 to 4.

### Example 6

In Example 6, the amount of component C is larger than in Examples 1 to 5. Specifically, in Example 6, the amount of component C is 50 g, while other conditions are the same as in Examples 1 to 5.

### Example 7

Example 7 includes treatment with an external release agent, and is different from Example 1 in this regard. Specifically, in Example 7, a surfactant diluted with IPA to 1000 ppm (trade name: Surflon S-141, manufactured by AGC SEIMI CHEMICAL) was used as an external release agent E2. The external release agent E2 was applied to the working surface of the mold by spin coating, followed by drying. The mold was then used. Other conditions employed in Example 7 are the same as in Example 1.

### Example 8

Example 8 includes treatment with an external release agent, and is different from Example 1 in this regard. Specifically, the working surface of the mold was subjected to water-repellent treatment with a commercial water-repellent finishing agent for glasses (E3 treatment), and the mold was then used. Other conditions employed in Example 8 are the same as in Example 1.

### Example 9

Example 9 is different from Example 1 in that the resin composition contains water as component D. Specifically, in Example 9, the resin composition contained 0.14 g of water as component D, giving a ratio (Hm/Cm) of 0.1 between the number of moles Cm of hydrolytic groups in the component C and the number of moles Hm of water added. Other conditions employed in Example 9 are the same as in Example 1.

### Example 10

In Example 10, the amount of component D is larger than in Example 9. Specifically, in Example 10, the resin composition contained 1.37 g of water as component D, giving a ratio (Hm/Cm) of 1.0 between the number of moles Cm of hydrolytic groups in the component C and the number of moles Hm of water added. Other conditions employed in Example 10 are the same as in Example 9.

### Example 11

In Example 11, the amount of component D is larger than in Example 10. Specifically, in Example 11, the resin composition contained 2.74 g of water as component D, giving a ratio (Hm/Cm) of 2.0 between the number of moles Cm of hydrolytic groups in the component C and the number of moles Hm of water added. Other conditions employed in Example 11 are the same as in Example 10.

### Example 12

In Example 12, the amount of component D is larger than in Example 11. Specifically, in Example 12, the resin composition contained 4.11 g of water as component D, giving a ratio (Hm/Cm) of 3.0 between the number of moles Cm of hydrolytic groups in the component C and the number of moles Hm of water added. Other conditions employed in Example 12 are the same as in Example 11.

### Example 13

Example 13 is different from Example 1 in that the resin composition does not contain component E1, and other conditions are the same as in Example 1.

### Comparative Example 1

Comparative Example 1 is different from Example 1 in amounts of component A and component B and also in that the resin composition of Comparative Example 1 does not contain component C. Specifically, in Comparative Example 1, the amount of component A1 is 95 g, and the number of moles Am of episulfide groups therein is 0.903. The amount of component B1 is 5 g, and the number of moles Bm of SH groups in the component is 0.055. Accordingly, the molar ratio Bm/Am between the component A and the component B is 0.061. Other conditions employed in Comparative Example 1 are the same as in Example 1.

### Comparative Example 2

Comparative Example 2 is different from Comparative Example 1 in amounts of component A and component B. Specifically, in Comparative Example 2, the amount of component A1 is 90 g, and the number of moles Am of episulfide groups therein is 0.856. The amount of component B1 is 10 g, and the number of moles Bm of SH groups in the component is 0.109. Accordingly, the molar ratio Bm/Am between the component A and the component B is 0.128. Other conditions employed in Comparative Example 2 are the same as in Comparative Example 1.

### Comparative Example 3

Comparative Example 3 is different from Comparative Example 2 in amounts of component A and component B. Specifically, in Comparative Example 3, the amount of component A1 is 85 g, and the number of moles Am of episulfide groups therein is 0.808. The amount of component B1 is 15 g, and the number of moles Bm of SH groups in the component is 0.164. Accordingly, the molar ratio Bm/Am between the component A and the component B is 0.203. Other conditions employed in Comparative Example 3 are the same as in Comparative Example 2.

### Comparative Example 4

Comparative Example 4 is different from Example 1 in that the resin composition does not contain component C, and other conditions are the same as in Example 1.

### Comparative Example 5

In Comparative Example 5, the amount of component C is smaller than in Example 1. Specifically, in Comparative Example 5, the amount of component C is 1 g, while other conditions are the same as in Example 1.

### Comparative Example 6

In Comparative Example 6, the amount of component C is smaller than in Example 1 and is larger than in Comparative Example 5. Specifically, in Comparative Example 6, the amount of component C is 5 g, while other conditions are the same as in Comparative Example 5.

### Comparative Example 7

Comparative Example 7 is different from Example 1 in that the amount of component C is 55 g, and other conditions are the same as in Example 1.

### Comparative Example 8

In Comparative Example 8, the amount of component D is larger than in Example 12. Specifically, in Comparative Example 8, the resin composition contained 5.49 g of water as component D, giving a ratio (Hm/Cm) of 4.0 between the number of moles Cm of hydrolytic groups in the component C and the number of moles Hm of water added. Other conditions employed in Comparative Example 8 are the same as in Example 12.

The plastic lenses of the above Examples 1 to 13 and Comparative Examples 1 to 8 were tested for heat resistance, yellowness, and refractive index.

Heat resistance: Using a TMA tester, Tg under a load of 50 g was measured.

The evaluation was made according to the following criteria.

Poor: less than 70° C.

Fair: 70° C. or more and less than 90° C.

Good: 90° C. or more

Yellowness: The produced plastic lenses were visually evaluated in a black box to evaluate yellowness. The evaluation was made according to the following criteria.

Poor: strong yellowness, making the lens impossible to use as a spectacle lens

Fair: somewhat conspicuous yellowness

Good: no yellowness or an extremely low degree yellowness that would cause no problem

Refractive index: Using an Abbe refractometer, the refractive index of e line of 546.6 nm at 20° C. was determined. The evaluation was made according to the following criteria.

-: unable to measure

Fair: less than 1.70

Good: 1.70 or More

Mold release property: A wedge was pressed against the glass mold and the edge surface of the plastic lens, which were stuck together by polymerization molding, to thereby separate the two, and the workability was evaluated. The evaluation was made according to the following criteria.

Poor: difficult to release from the mold

Fair: careful release required, otherwise causing cracking or breaking in the plastic lens and the glass mold

Good: no problem to release from the mold

Excellent: excellent mold release property exhibited

The experimental conditions and the test results of Examples 1 to 13 and Comparative Examples 1 to 8 given above are shown in Table 1.

TABLE 1

| | | | | | Internal mold | External | External | Heat | | Refractive | Mold |
|---|---|---|---|---|---|---|---|---|---|---|---|
| | Compo- | Compo- | Compo- | Water | release | mold release | mold release | resistance | | index | release |
| | nent A | nent B | nent C | (Hm/Cm) | agent E1 | agent E2 | agent E3 | (Tg) | Yellowness | (ne) | property |
| Example 1 | 80 g | 20 g | 6 g | | 10 ppm | | | Good | Good | Good | Good |
| | | | | | | | | (90° C.) | | 1.73 | |
| Example 2 | 80 g | 20 g | 10 g | | 10 ppm | | | Good | Good | Good | Good |
| | | | | | | | | (93° C.) | | 1.72 | |
| Example 3 | 80 g | 20 g | 20 g | | 10 ppm | | | Good | Good | Good | Good |
| | | | | | | | | (102° C.) | | 1.70 | |
| Example 4 | 80 g | 20 g | 30 g | | 10 ppm | | | Good | Good | Fair | Good |
| | | | | | | | | (107° C.) | | 1.68 | |
| Example 5 | 80 g | 20 g | 40 g | | 10 ppm | | | Good | Good | Fair | Good |
| | | | | | | | | (110° C.) | | 1.66 | |
| Example 6 | 80 g | 20 g | 50 g | | 10 ppm | | | Good | Good | Fair | Good |
| | | | | | | | | (112° C.) | | 1.63 | |
| Example 7 | 80 g | 20 g | 6 g | | 10 ppm | Treated | | Good | Good | Good | Excellent |
| | | | | | | | | (90° C.) | | 1.73 | |
| Example 8 | 80 g | 20 g | 6 g | | 10 ppm | | Treated | Good | Good | Good | Excellent |
| | | | | | | | | (90° C.) | | 1.73 | |
| Example 9 | 80 g | 20 g | 6 g | 0.14 g | 10 ppm | | | Good | Good | Good | Good |
| | | | | (0.1) | | | | (92° C.) | | 1.73 | |
| Example 10 | 80 g | 20 g | 6 g | 1.37 g | 10 ppm | | | Good | Good | Good | Good |
| | | | | (1.0) | | | | (96° C.) | | 1.72 | |
| Example 11 | 80 g | 20 g | 6 g | 2.74 g | 10 ppm | | | Good | Good | Good | Good |
| | | | | (2.0) | | | | (97° C.) | | 1.70 | |
| Example 12 | 80 g | 20 g | 6 g | 4.11 g | 10 ppm | | | Good | Good | Fair | Good |
| | | | | (3.0) | | | | (97° C.) | | 1.68 | |
| Example 13 | 80 g | 20 g | 6 g | | | | | Good | Good | Good | Poor |
| | | | | | | | | (90° C.) | | 1.73 | |
| Comparative | 95 g | 5 g | | | 10 ppm | | | Good | Poor | Good | Good |
| Example 1 | | | | | | | | (98° C.) | | 1.73 | |
| Comparative | 90 g | 10 g | | | 10 ppm | | | Fair | Fair | Good | Good |
| Example 2 | | | | | | | | (80° C.) | | 1.73 | |
| Comparative | 85 g | 15 g | | | 10 ppm | | | Poor | Good | Good | Good |
| Example 3 | | | | | | | | (68° C.) | | 1.74 | |
| Comparative | 80 g | 20 g | | | 10 ppm | | | Poor | Good | Good | Good |
| Example 4 | | | | | | | | (55° C.) | | 1.74 | |
| Comparative | 80 g | 20 g | 1 g | | 10 ppm | | | Fair | Good | Good | Good |
| Example 5 | | | | | | | | (70° C.) | | 1.74 | |
| Comparative | 80 g | 20 g | 5 g | | 10 ppm | | | Fair | Good | Good | Good |
| Example 6 | | | | | | | | (82° C.) | | 1.73 | |
| Comparative | 80 g | 20 g | 55 g | | 10 ppm | | | Good | Poor | Poor | Good |
| Example 7 | | | | | | | | (110 or | (white | (unable to | |
| | | | | | | | | more) | appearance) | measure) | |
| Comparative | 80 g | 20 g | 6 g | 5.49 g | 10 ppm | | | Good | Poor | Poor | Good |
| Example 8 | | | | (4.0) | | | | (98° C.) | (white | (unable to | |
| | | | | | | | | | appearance) | measure) | |

As shown in Comparative Examples 1 to 4 in the Table 1, in the past, heat resistance, yellowness, and refractive index are balanced by use of two components: component A which is an episulfide compound and component B which a thiol compound. However, when the amount of compound B is increased for the purpose of improving yellowness and refractive index, heat resistance is reduced in inverse proportion thereto. The glass transition temperature Tg in Comparative Example 4 was as extremely low as 55° C., indicating poor heat resistance.

In contrast, the resin composition of Example 1 contains component C in addition to component A and component B. As a result, the glass transition temperature Tg thereof was 90° C., indicating excellent heat resistance, while yellowness was also satisfactory. Further, the refractive index ne was 1.73, and the lens was thus usable as a spectacle lens. In addition, because 10 ppm of E1 was added as an internal release agent, the mold release property between the glass mold and the lens was excellent.

As in Example 1, component C was also added in Comparative Examples 5 and 6. However, because of the small added amount, the glass transition temperatures Tg were as low as 90° C. or less.

The table shows that the products of Examples 2 to 6 have excellent heat resistance and satisfactory yellowness as in Example 1, and that the glass transition temperature Tg is increased with an increase in the amount component C.

In contrast, in Example 7, the proportion of component C is 55 parts by mass per 100 parts by mass of the total of component A and component B. Accordingly, although the glass transition temperature Tg was as extremely high as 110° C. more, and the heat resistance was excellent, the yellowness thereof was extremely unfavorable. Due to its cloudy appearance, it was impossible to determine refractive index.

This leads to that when the proportion of component C is 6 to 50 parts by mass per 100 parts by mass of the total of component A and component B, then excellent heat resistance, yellowness, and refractive index are resulted.

Further, it is also indicated that when the proportion of component C is 6 to 20 parts by mass per 100 parts by mass of the total of component A and component B, reduction in refractive index can be suppressed to give a high refractive index of 1.70 or more, so this is a more preferred range.

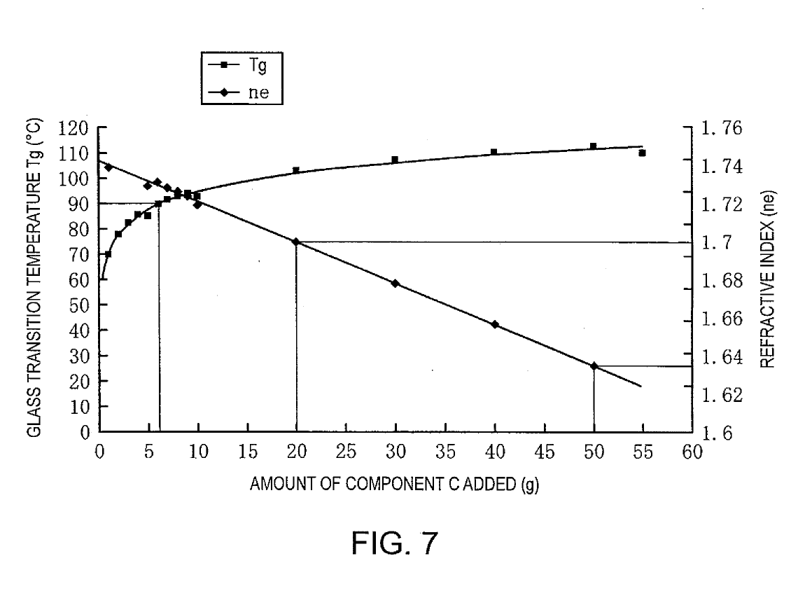

Such relations are shown in FIG. 7. FIG. 7 is a graph showing, regarding the Examples and Comparative Examples, the relation between the amount of component C added and the glass transition temperature and also the relation between the amount of component C added and the refractive index.

As shown in FIG. 7, when the amount of component C added is 6 g (6 parts by mass) or more, then the resulting glass transition temperature Tg is 90° C. or more. When the amount of component C added is 50 g (50 parts by mass) or less, then the resulting refractive index can be 1.63 or more, and when the amount of component C added is 20 g (20 parts by mass) or less, then the resulting refractive index can be 1.70 or more.

Examples 7 and 8 are different from Example 1 in that these examples include treatment with an external release agent. This further improves the mold release property which is also excellent in the past.

In Examples 9 to 12, unlike in Example 1, the resin composition contains water as component D, and such water improves heat resistance. Specifically, the glass transition temperature Tg in Example 1 is 90° C., whereas it is 92° C. in Example 9, 96° C. in Example 10, and 97° C. in Example 11 and Example 12. The differences in glass transition temperature Tg among Examples 9 to 12 are due to the differences in the ratio Hm/Cm of the number of moles Hm of water added to the number of moles Cm of hydrolytic groups in component C. The Hm/Cm ratio is 0.1 in Example 9, 1.0 in Example 10, 2.0 in Example 11, and 3.0 in Example 12. This leads to that when Hm/Cm is 0.1 or more and 3 or less, heat resistance can be improved, and also the product can be prevented from becoming clouded, providing good appearance.

Further, it is also indicated that when Hm/Cm is 0.1 or more and 2 or less, reduction in refractive index can be suppressed, whereby a high refractive index of 1.70 or more can be obtained, so this is a more preferred range.

The invention is not limited to the above embodiment, and, to the extent that the advantages of the invention can be provided, any deformation, improvement, and the like are encompassed by the scope of the invention.

For example, although the resin composition was for spectacle plastic lenses in the above embodiment, the resin compositions according to other aspects of the invention may be for use in the production of dust-proof glasses, capacitor lenses, prisms, and optical discs.

In addition, the method for producing a spectacle lens is not limited to the method using a casting mold 150 as in the above embodiment.

The invention can be used for a spectacle plastic lens, and it also can be used for a resin composition for a dust-proof glass, a capacitor lens, a prism, or an optical disc.

The entire disclosure of Japanese Patent Application Nos: 2008-290662, filed Nov. 13, 2008 and 2009-151994, filed Jun. 26, 2009 are expressly incorporated by reference herein.

What is claimed is:

1. A resin composition obtained by polymerizing and curing a polymerizable composition at least containing:
component A: a compound having in one molecule at lease one episulfide structure represented by the following formula (1): 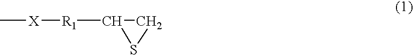
wherein X represents S or C, and R₁ represents C₁₋₁₀ hydrocarbon,
component B: a compound having per molecule at least one SH group, and
component C: an organosilicon compound represented by the following formula (2):
R¹ₘR²ₚSiX¹₄₋ₚ₋ₘ (2)
wherein R¹ is an organic group having a polymerizable reaction group, R² is a C₁₋₆ hydrocarbon group, X¹ is a hydrolytic group, m is 0 or 1, and p is 0 or 1,
the component C being present in a proportion of 6 parts by mass or more and 50 parts by mass or less per 100 parts by mass of the total of the component A and the component B.

2. A resin composition according to claim 1, wherein:
the component C is present in a proportion of 6 parts by mass or more and 20 parts by mass or less.

3. A resin composition according to claim 1, wherein:
the component A is an episulfide compound represented by the following formula (3): 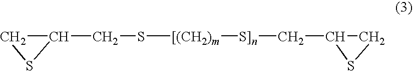
wherein m represents 0 to 6, and n represents 0 to 4.

4. A resin composition according to claim 1, wherein:
the component A has in one molecule at least one disulfide bond.

5. A resin composition according to claim 1, wherein:
an internal release agent is further added to the polymerizable composition, and the polymerizable composition is then polymerized and cured.

6. A resin composition according to claim 1, wherein:
the working surface of a mold that is used for polymerizing the polymerizable composition is coated with a release agent or subjected to surface treatment having a release effect.

7. A resin composition according to claim 1, wherein:
water is further added to the polymerizable composition, and the polymerizable composition is then polymerized and cured.

8. A resin composition according to claim 7, wherein:
0.1≦(Hm/Cm)≦3, taking the number of moles of hydrolytic groups in the component C in the polymerizable composition as Cm and the number of moles of water added as Hm.

9. A resin composition according to claim 8, wherein: 0.1≦(Hm/Cm)≦2.

10. A resin composition according to claim 1, wherein:
the resin composition is for spectacle plastic lenses.
